(19) United States
(12) Patent Application Publication
(10) Pub. No.: US 2023/0320939 A1
(43) Pub. Date: Oct. 12, 2023

(54) Oral Development Teething Ring

(71) Applicant: Mallory Millet, Baton Rouge, LA (US)

(72) Inventor: Mallory Millet, Baton Rouge, LA (US)

(21) Appl. No.: 18/205,685

(22) Filed: Jun. 5, 2023

Related U.S. Application Data
(63) Continuation-in-part of application No. 17/219,515, filed on Mar. 31, 2021.

(51) Int. Cl. A61J 17/02; A61J 17/00

(52) U.S. Cl. CPC A61J 17/02; A61J 17/107; A61J 17/1115

(57) ABSTRACT

The disclosure is the only product of its kind that takes the standard concept of a teething device and modifies it to adequately cater to the oral development and motor skills of all infants The disclosure is uniquely designed to adapt to the hands of infants and to feature colors attractive to young children to help promote long term use. The disclosed teething ring device for an oral development of a child therefore includes a hub comprising a weighted ring, some teething spokes fixed outwardly from the hub and some in a hinged relation to the hub and an attachment loop emanating from the hub for a pacifier clip.

### CROSS REFERENCE

The present application is a continuation in part of U.S. Pat. Application 17/219,515 filed Mar. 31, 2021 for Mallory Millet titled Oral Development Teething Ring incorporated in its entirety into the present utility patent application of the same title.

### BACKGROUND

Teething is a natural and essential process for young children under the age of one. However, this stage often causes discomfort and an unpleasant sensation in little ones. Current teething instruments are unable to resolve such discomfort and unpleasantness adequately and maintain optimal oral development. There have been no products available as original equipment or as an aftermarket to address this problem.

An apparatus or device to aid teething children and ease the discomfort and unpleasant sensation that accompany teething. There have been no products available as original equipment or as an aftermarket to address this problem either.

There exists a need for Teething Ring that is not being met by any known or disclosed device or system of present.

### SUMMARY OF THE INVENTION

The main purpose of the Oral Development Teething Ring is to facilitate optimal oral development in infant children. The present invention alleviates the discomfort and unpleasant sensations that accompany teething for young children in a convenient, simple and efficient manner. This apparatus also helps maintain and encourage an optimal oral development for teething children.

The disclosed teething ring device for an oral development of a child therefore includes a hub comprising a weighted ring, some teething spokes extending outwardly from an outside complete circumference of the hub or the weighted ring and some in a hinged relation to the hub or the weighted ring and an attachment boss or loop emanating from the hub for a pacifier clip.

The plurality of teething spokes are hinged in a relation to the hub via a protuberance emanating from the hub received into a complementary recess in each of the plurality of teething spokes. Also, the hinged relation of the teething spokes to the weighted ring comprises a swivel pivot disposed between the slotted outside complete circumference of the weighted ring and the respective end of each of the plurality of teething spokes.

### BRIEF DESCRIPTION OF THE DRAWINGS

FIG. 1 is a front perspective view of an Oral Development Teething Ring apparatus with fixed spokes in accordance with an embodiment of the present disclosure.

FIG. 2 is a front perspective of an Oral Development Teething Ring apparatus with hinged spokes in accordance with an embodiment of the present disclosure.

FIG. 3 is a sectional view AA of FIG. 2 through the hub weighted ring A and a spoke in accordance with an embodiment of the disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

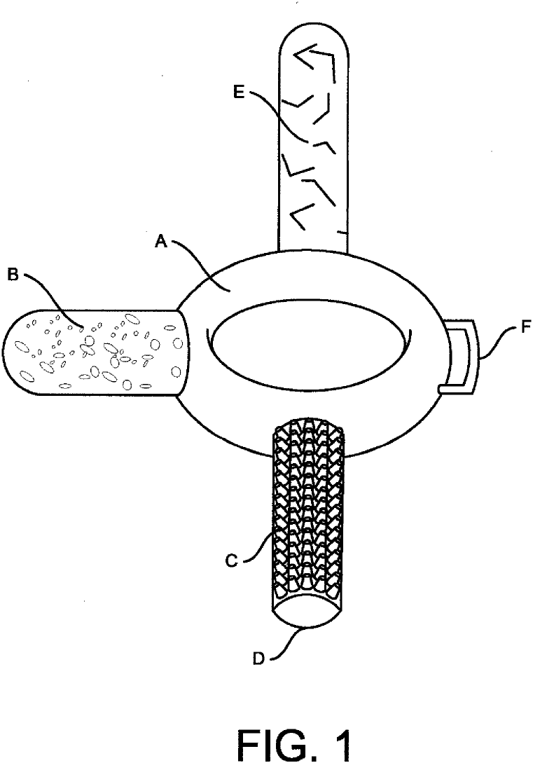

FIG. 1 is a front perspective view of the Oral Development Teething Ring apparatus with fixed spokes in accordance with an embodiment of the present disclosure. The view shows the following: a hub comprising a weighted ring (which comes in different colors and patterns) referenced as A., Soft silicone spoke filled with fluid referenced as B., Silicone squeaky spoke with teeth on one side referenced as C., Textured side of squeaky spoke referenced as D., Spoke made of crinkled material referenced as E., Pacifier clip referenced as F, in accordance with an embodiment of the present disclosure.

The present disclosed Oral Development Teething Ring, also known as “Myo Mouth”, is a weighted ring embedded with spokes of various lengths and materials that serves as a modern and improved teether. Comprised of lightweight yet durable material, the disclosure is also known as Myo Mouth, features three silicone spokes designed to adapt to the structure of the infant’s mouth and support the proper growth of teeth. The three spokes consist of one spoke filled with fluid, one with additional smaller protruding spokes, and another spoke composed of soft textured material, each promote proper tongue movement and functional jaw strength via the variation of spoke usage. As an infant applies pressure to the oral accessory, intriguing high-pitched sounds are produced to further captivate his or her attention. Myo Mouth is intended to be available in a variety of colors and patterns that best appeal to the senses of children. Myo Mouth may prove to be an essential and therapeutic tool helping to ensure proper oral exploration and growth for infant children.

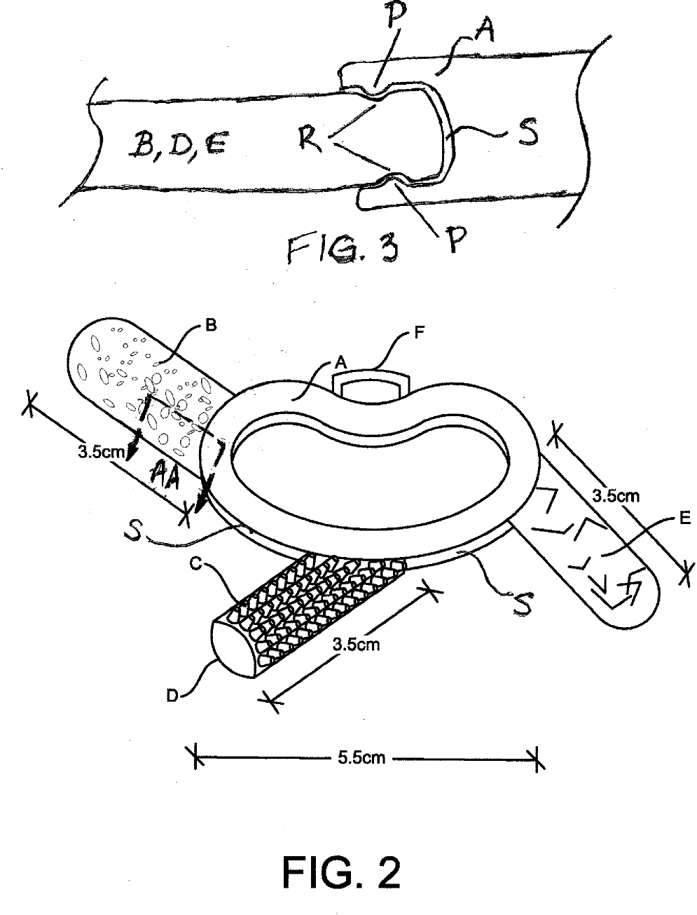

FIG. 2 is a front perspective view of the Oral Development Teething Ring apparatus with hinged spokes in accordance with an embodiment of the present disclosure. The view shows the following: a hub comprising a weighted ring (which comes in different colors and patterns) referenced as A., Soft silicone spoke filled with fluid referenced as B., Silicone squeaky spoke with teeth on one side referenced as C., Textured side of squeaky spoke referenced as D., Spoke made of crinkled material referenced as E., wherein the hub comprises a slotted outside complete circumference S adapted to receive an end of each of the plurality of teething spokes and a Pacifier clip referenced as F, in accordance with an embodiment of the present disclosure.

FIG. 3 is a sectional view AA of FIG. 2 through the hub weighted ring A and a spoke in accordance with an embodiment of the disclosure. The sectional view AA shows the spoke B received into the slotted outside complete circumference S and the protuberance or swivel pivot P received into the complementary recess R in two places as referenced by R exemplary of spokes B, D and E.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A teething ring for oral development comprising:
a hub comprising a ring;
a plurality of teething spokes emanating outwardly from the hub;
wherein the hub comprises a slotted outside complete circumference adapted to receive an end of each of the plurality of teething spokes; and
an attachment boss emanating from the hub.

2. The teething ring of claim 1, wherein the plurality of teething spokes comprises a soft silicone spoke filled with a fluid.

3. The teething ring of claim 1, wherein the plurality of teething spokes comprises a silicone squeaky spoke with teeth on one side.

4. The teething ring of claim 1, wherein the plurality of teething spokes comprises a spoke comprising a crinkled material.

5. The teething ring of claim 1, wherein the plurality of teething spokes are fixed in a relation to the slotted outside complete circumference of the hub.

6. The teething ring of claim 1, wherein the plurality of teething spokes are hinged in a relation to the hub via a protuberance emanating from the hub received into a complementary recess in each of the plurality of teething spokes.

7. The teething ring of claim 1, wherein the hub comprises a hollow weighted ring filled with a fluid.

8. The teething ring of claim 1, wherein the hub comprises a slotted outside circumference portion adapted to receive an end of each of the plurality of teething spokes.

9. The teething ring of claim 1, wherein a shape of the ring is circular.

10. The teething ring of claim 1, wherein a shape of the ring is elliptical.

11. The teething ring of claim 1, wherein a shape of the ring is heart like.

12. The teething ring of claim 1, wherein the attachment boss is a pacifier clip loop.

13. The teething ring of claim 1, wherein each of the plurality of teething spokes is ninety degrees offset from another.

14. The teething ring of claim 1, wherein the attachment boss is a tether.

15. The teething ring of claim 1, wherein at least one of the plurality of teething spokes is hollow and shares a fluid therein with a hollow core of the ring.

16. The teething ring of claim 1, wherein the ring is weighted with a fluid internal thereto.

17. A teething ring device for an oral development of a child, the teething ring device comprising:
a hub comprising a weighted ring;
a plurality of teething spokes fixed outwardly from the hub, wherein the hub comprises a slotted outside complete circumference adapted to receive an end of each of the plurality of teething spokes; and
an attachment loop emanating from the hub for a pacifier clip.

18. A teething ring system for an oral development of a child, the teething ring system comprising:
a hub comprising a weighted ring;
a plurality of teething spokes in a hinged relation to the weighted ring, wherein the weighted ring comprises a slotted outside complete circumference adapted to receive an end of each of the plurality of teething spokes; and
an attachment loop emanating from the hub.

19. The teething ring system of claim 18, wherein the hinged relation of the plurality of teething spokes to the weighted ring comprises a swivel pivot disposed between the slotted outside complete circumference of the weighted ring and the respective end of each of the plurality of teething spokes.

20. The teething ring system of claim 18, wherein the plurality of teething spokes comprises a corn cob like teething spoke having a kernel like surface.
